(19) United States
(12) Patent Application Publication
(10) Pub. No.: US 2009/0262055 A1
(43) Pub. Date: Oct. 22, 2009

(54) Method and System for Grayscale Resolution Enhancement in Video Systems

(76) Inventors: Donald Paul Bilger, Livonia, MI (US); Mahendra Somasara Dassanayake, Bloomtield Hills, MI (US)

Correspondence Address: RICHARD M. SHARKANSKY, PO BOX 557, MASHPEE, MA, 02649, US

(21) Appl. No.: 12/104,912

(22) Filed: Apr. 17, 2008

(51) Int. Cl. G09G 3/36

(52) U.S. Cl. 345/89

(57) ABSTRACT

A method and system for enhancing the grayscale resolution of display systems using 8-bit imaging arrays. The grayscale resolution is increased by providing a resolution greater than 8 bits. The on-time for each shade is subdivided in two sub-frames. During a first subframe, a full intensity light source is turned on and the imaging array processes five most significant bits of data, while least significant bits are stuffed with zeros. During a second subframe, the light source is turned on at reduced intensity and the imaging array processes the three least significant bits, which are left-shifted. The data byte for the second subframe is filled out using Digital Signal Processor (DSP) data obtained by over-sampling or interpolation. The lower order bits may be also stuffed with zeros.

### TECHNICAL FIELD

This invention relates generally to video systems and more particularly to method and system for grayscale resolution enhancement in video systems

### BACKGROUND

As is known in the art, conventional video systems provide a large color palette, but are limited in grayscale resolution. As an example, a typical DLP-based or LCD-based projection video system processing 24-bit color from a computer has 24 data bits per pixel—8 bits for red, 8 bits for green and 8 bits for blue. While this provides more than 16.7 million colors, the 8-bit resolution per color limits the grayscale to 256.

Several techniques have been suggested to increase grayscale resolution. A patent to Kassmann (U.S. Pat. No. 6,040,791) provides for a System and Method for Grey Value Expansion of Pixel Data. Described is a system that may convert a received image data, having a lower bit resolution, to a higher bit resolution. The original bits of the received pixel byte are copied into the most significant bits of a new pixel byte. The copying process is continued with the original bits proceeding from most significant bit to the least significant bit of the new pixel byte until the entire new pixel byte is filled. The conversion or expansion produces a new pixel byte which is a compilation of the received pixel byte wherein the received pixel byte has been repeated at least two times in the new pixel byte. The number of repeating received pixel byte can be varied and the method utilizes multiplication or add operations to realize the bit resolution conversion (see abstract; column 4, lines 1-50; and column 5, lines 26-35).

A patent to Worley et al. (U.S. Pat. No. 6,072,452), provides for a System and Method for Using Forced States to Improve Gray Scale Performance of a Display. Described electronic display drivers provide improved gray scale performance using forced states. A forced state may be either an “On” or “Off” state. The driver receives an 8-bit gray scale display data stream and a forced state generator inserts forced states into the display data stream. The addition of forced states to the display data stream improves the gray scale resolution of the system. After inserting forced states into the display data stream the modified display data is transferred to an LCD (see abstract; column 2, lines 44-45; column 8, lines 5-6; column 8, lines 8-14; column 10, lines 3-4; and column 10, lines 11-12).

A patent to Kobayashi (U.S. Pat. No. 6,914,614 B2 provides for a Color Display Method and Semiconductor Integrated Circuit Using the Same. Described is a color display method on an LCD display to expand the range of displayable color tones without increasing the number of bits per image data. A first image data unit representing a first range of 0-255 continuous color tones is mapped to a second image data unit having an expanded bit count. A driver IC includes an image data conversion circuit that converts first image data units into second image data units on the basis of a conversion algorithm. Further, the image data unit approximates the display of true colors, which are typically associated with a higher resolution color (see abstract; column 2, lines 56-61; and column 5, lines 46-53).

A patent to Kojima et al. (U.S. Pat. No. 7,053,868 B1 provides for Plasma Display Apparatus. Described is a plasma display apparatus to display a high quality image. The plasma display apparatus turns on a desired combination of the sub-frames to increase the resolution of the luminance without changing the number of bits of the input video data. A data converter receives the eight-bits input video data for each RGB color and uses a conversion table to convert the RGB input video data into the nine-bits display data. The system also specifies the ON/OFF states of the sub-frames (see abstract; column 6, lines 43-46; column 6, line 66-column 7, line 5; and column 7, lines 13-17).

### SUMMARY

In accordance with the present invention, a method is provided for enhancing the grayscale resolution of a display system. The method includes: receiving data having N bits for display on the display system; and presenting the frame of data to the display as a sequence of subframes of data, each subframe having a fractional portion of the N bits, each subframe of data being presented to the display with the display being illuminated with a light source having a corresponding different intensity.

In one embodiment, each one of the subframes has N bits and wherein a first one of the subframes has as the most significant bits thereof the most significant bit fractional portion of the N bits of the frame and wherein a second one of the subframes has as the most significant bits thereof the least significant bit fractional portion of the N bits of the frame.

In one embodiment, when the first one of the subframes of data is presented to the display, the display is illuminated with the light source having a relatively high intensity and wherein when the second one of the subframes of data is presented to the display, the display is illuminated with the light source having a relatively low intensity.

In one embodiment, a method is provided for enhancing the grayscale resolution of a display system, comprising: receiving a frame of data having data for each of a plurality of different colors; selecting N-bits of data from one of the plurality of different colors; separates the N-bits of data into two subframes: the first subframe having as the most significant bits thereof the N-n most significant bits of selected color data; the second subframe having as the most significant bits thereof the remaining (n) bits of selected color data; applying the first subframe of data to the display with a light source for the display having a relatively high intensity; applying the second frame of data to the display with the light source for the display having a relatively low intensity; and repeating the process until all colors have been applied to the display.

In accordance with another feature of the invention, a system is provided for enhancing the grayscale resolution of a display system. The system includes: a display; a light source for illuminating the display; a buffer system for receiving data having N bits for display on the display and for presenting the frame of data to the display as a sequence of subframes of data, each subframe having a fractional portion of the N bits; and a controller for controlling illumination intensity of the light source with each subframe of data being presented to the display with the display being illuminated with the light source having a corresponding different intensity.

In one embodiment, each one of the subframes has N bits and wherein a first one of the subframes has as the most significant bits thereof the most significant bit fractional portion of the N bits of the frame and wherein a second one of the subframes has as the most significant bits thereof the least significant bit fractional portion of the N bits of the frame.

In one embodiment, when the first one of the subframes of data is presented to the display, the display is illuminated with the light source having a relatively high intensity and wherein when the second one of the subframes of data is presented to the display, the display is illuminated with the light source having a relatively low intensity. In accordance with the invention, a method and system are provided for enhancing the grayscale resolution of display systems using 8-bit imaging arrays. The grayscale resolution is increased by providing a resolution greater than 8 bits. The on-time for each shade is subdivided in two sub-frames. During a first subframe, a full intensity light source is turned on and the imaging array processes five most significant bits of data, while least significant bits are stuffed with zeros. During a second subframe, the light source is turned on at reduced intensity and the imaging array processes the three least significant bits, which are left-shifted. The data byte for the second subframe is filled out using Digital Signal Processor (DSP) data obtained by over-sampling or interpolation. The lower order bits may be also stuffed with zeros.

In one embodiment, the relatively low intensity of the backlight in the second sub-frame preferably is a precisely defined fraction of the higher intensity in the first sub-frame. For the case, for example, where the input data byte is split into groups of 5 and 3 bits, the 3-bit grouping must be left-shifted by 5 bit positions to align it to the most significant bit position in the second sub-frame. This corresponds to multiplication by 2⁵, or 32, so the backlight intensity should be reduced by the same factor.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a display system according to the invention;

FIG. 2 is a block diagram showing an exemplary one of three grayscale processors used in the system of FIG. 1 according to the invention;

FIG. 3 is a timing diagram useful in undertaking the grayscale processor of FIG. 2; and

FIG. 4 is a flowchart of the process according to the invention.

Like reference symbols in the various drawings indicate like elements.

### DETAILED DESCRIPTION

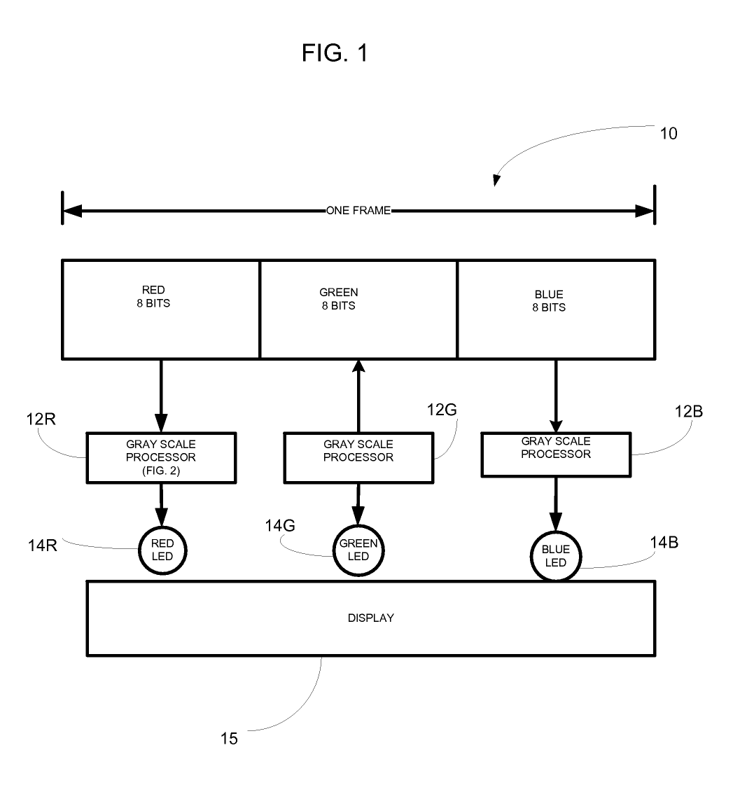

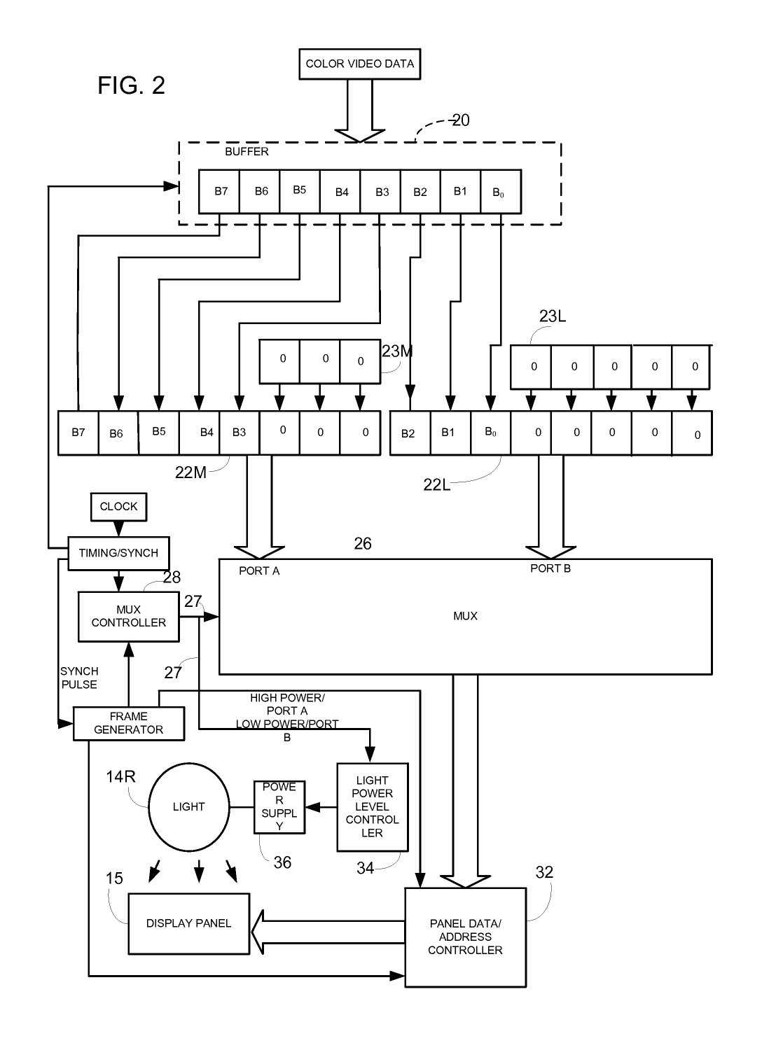

Referring now to FIG. 1, a DLP-based or LCD-based projection video system 10 processing 24-bit color is shown. Each frame has 24 data bits per pixel—8 bits for red, 8 bits for green and 8 bits for blue. Each color is fed to a corresponding one of three identical grayscale processors 12R, 12G and 12B, respectively, an exemplary one thereof, here processor 12R being shown in more detail in FIG. 2. Each one of the processor feds a corresponding one of three, high output LEDs 14R, 14G and 14B, respectively, as shown. These LEDs powered by the grayscale processors in a manner to be described so that they may deliver their full light output to a display panel 15, a calibrated fraction of the light output to the display 15, or no output to the display 15. Briefly, the present invention works as follows to enhance low-level grayscale resolution and/or extend it beyond 8 bits:
The digital video signal may be processed, by interpolation or oversampling, to provide a resolution greater than 8 bits per color. If the digital video source provides higher grayscale resolution than 8 bits per color, the source signal may be used directly.
The imaging array is switched at six times the frame repetition rate of the incoming video signal (e.g. 360 Hz switching rate for a 60 Hz NTSC signal).

One frame of video data

| | | | | | |
|---|---|---|---|---|---|
| Red | Red | Green | Green | Blue | Blue |
| High | Low | High | Low | High | Low |

For the first subframe, the five most significant bits of red data are used to drive the imaging array. The lowest three bits of the data byte are stuffed with zeros. The red LED is turned on at full intensity.
For the second subframe, the remaining three bits of red data plus any additional lower-order bits provided by the source or generated by digital signal processing are used to drive the imaging array. These bits are left-shifted within the data byte so that the data starts in the most significant bit position of the data byte. The red LED is turned on at 1/32 of full light intensity to provide an optical shift of the subframe to its proper position in the grayscale. The use of the most significant data bits causes the imaging array to operate in its most linear region, and the use of the light source at reduced intensity provides the scaling to extend the low-level grayscale resolution.
The process is repeated for the remaining four subframes, with the green LED used in subframes 3 and 4 and the blue LED used in subframes 5 and 6.

Similar processing may be used with video systems that use three T-LCDs, each with its own LED source, instead of a single shared imaging array. In this case, the imaging arrays switch at twice the frame rate of the incoming video signal. The signal processing and LED output drive work as described above for the case of a system with a single imaging array. An analogous approach may be used for monochrome video systems that combine a single imaging array with a white or monochrome color light source.

If desired, a number of bits other than five may be processed in the first subframe. The LED light intensity for the second subframe would then be Pmax/(2̂n), where Pmax is the LED intensity during the first subframe and n is the number of bits processed in the first subframe.

More particularly, referring to FIG. 2, the grayscale processor 12R is shown in more detail to include an 8-bit buffer register 20 fed by the 8 bits of the red color portion of the frame. The bits are stored from the least significant bit, B₀, to the most significant bit B₇, as shown. The 5 most significant bits B₇-B₃ are stored in a first subframe register 22M and the three least significant bits B₂-B₀ are stored in a second subframe register 22L.

More particularly, the first subframe register 22M is an 8 bit register arranged to store an 8 bit digital word having bit B₇ in the most significant bit position of such 8 bit digital word. Zeros, stored in a register 23M are stored in the three least significant bit locations of the 8 bit digital word. It should be understood that the zeros may be preloaded into the register 22M. Therefore, the 8 bit digital word stored in the first subframe register 22M, from most significant bit to the least significant bit is: B₇B₆B₅B₄B₃000, as shown.

The second subframe register 22L is an 8 bit register arranged to store an 8 bit digital word having bit B₂ in the most significant bit position of such 8 bit digital word. Zeros, stored in a register 23L are stored in the five least significant bit locations of the 8 bit digital word. It should be understood that the zeros may be preloaded into the register 22M. Therefore, the 8 bit digital word stored in the first subframe register 22M, from most significant bit to the least significant bit is: B₂B₁B₀00000, as shown.

The grayscale processor 20R includes a multiplexer (MUX) 26 having a pair of input ports; input Port A fed by the 8 bit register 22M and input Port B fed by the 8 bit register 22L.

A MUX controller 28 provides a control signal on line 27 to the MUX 26 to couple a selected one of the pair of input ports (i.e., either input port A or input Port B) to the output of the MUX 26 and then to the display panel 15 through a conventional panel data/address controller 32. The control signal on line 27 is also fed to a light power level controller 34, as shown. The light power controller 34 is fed to the power supply 36 of the LED 14R, as shown.

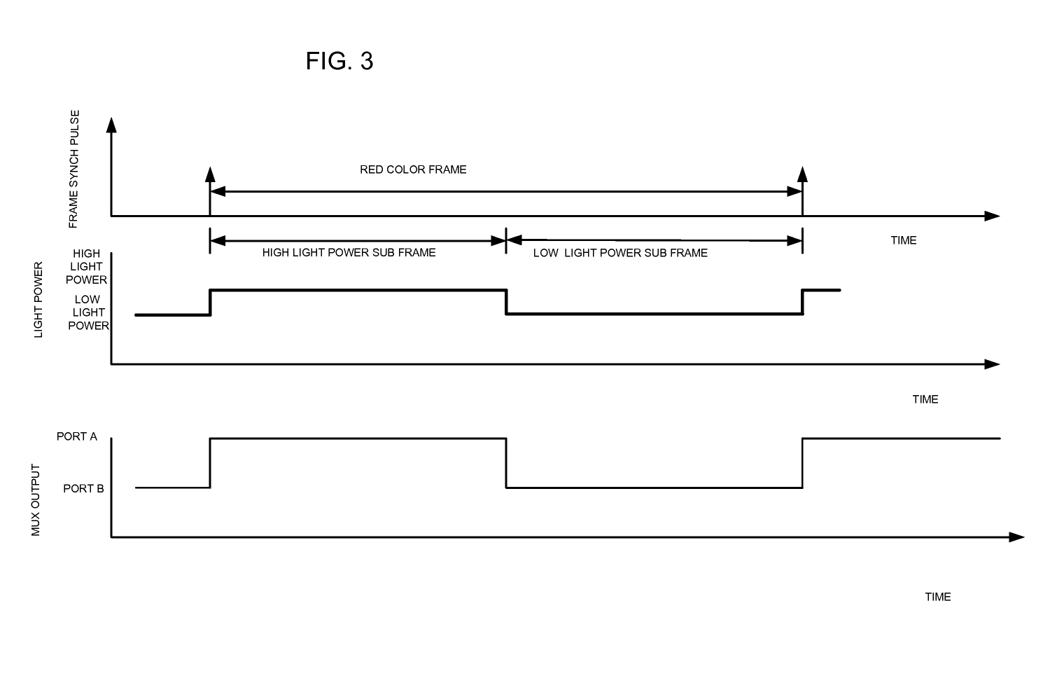

In operation, and referring to FIG. 3, when control signal on line 27 selects the output of register 22M for presenting data to the panel 30, the control signal on line 27 causes the light power level controller 34 to drive the power supply 26 with a relatively high level of power with the LED 14R thereby illuminating the display 30 with a relatively high level of illumination; whereas when control signal on line 27 selects the output of register 22L for presenting data to the panel 30, the control signal on line 27 causes the light power level controller 34 to drive the power supply 26 with a relatively low level of power with the LED 14R thereby illuminating the display 30 with a relatively low level of illumination.

Thus, for the first subframe, the five most significant bits of red data are used to drive the imaging array. The lowest three bits of the data byte are stuffed with zeros. The red LED is turned on at full intensity.

For the second subframe, the remaining three bits of red data plus any additional lower-order bits provided by the source or generated by digital signal processing are used to drive the imaging array. These bits are left-shifted within the data byte so that the data starts in the most significant bit position of the data byte. The red LED is turned on at 1/32 of full light intensity to provide an optical shift of the subframe to its proper position in the grayscale. The use of the most significant data bits causes the imaging array to operate in its most linear region, and the use of the light source at reduced intensity provides the scaling to extend the low-level grayscale resolution.

The process is repeated for the remaining four subframes, with the green LED used in subframes 3 and 4 and the blue LED used in subframes 5 and 6.

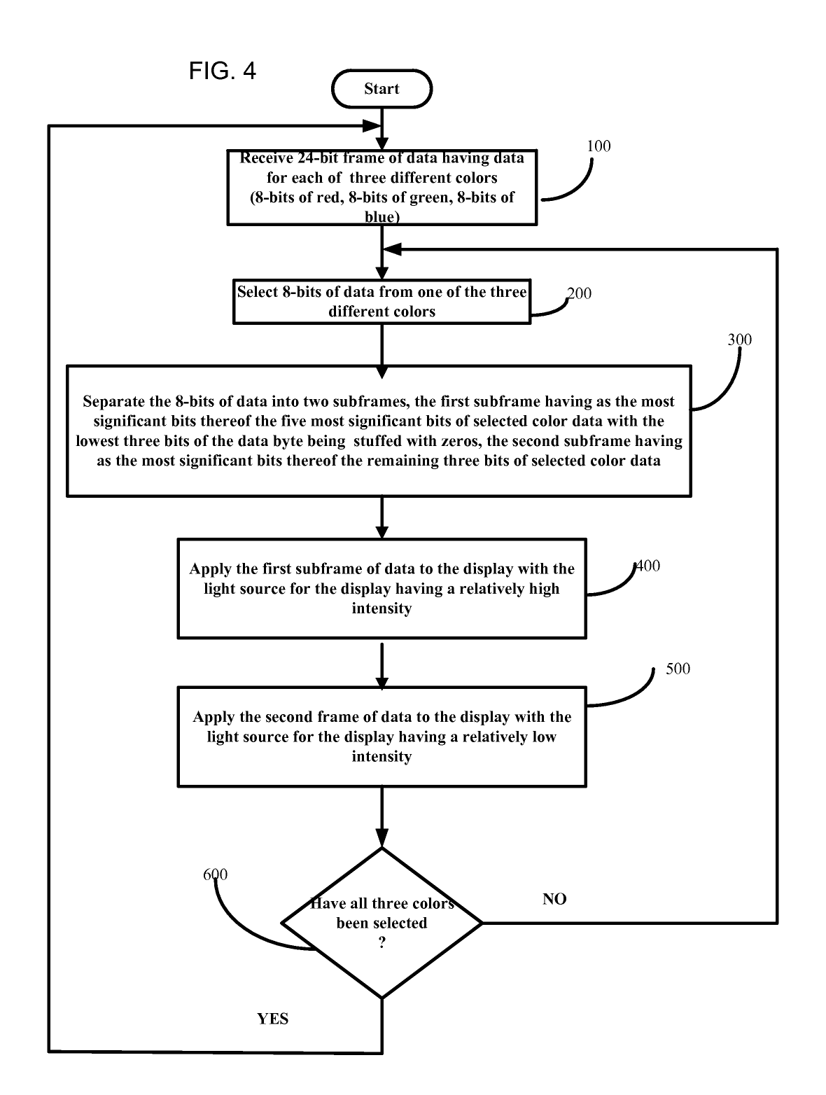

More particularly, referring to FIG. 4, a flowchart of the process is shown. The system receives a 24-bit frame of data having data for each of three different colors; e.g., 8-bits of red, 8-bits of green, 8-bits of blue, Step 100. Next, the process selects 8-bits of data from one of the three different colors, Step 200. Next, the process separates the 8-bits of data into two subframes: the first subframe having as the most significant bits thereof the five most significant bits of selected color data with the lowest three bits of the data byte being stuffed with zeros; the second subframe having as the most significant bits thereof the remaining three bits of selected color data, Step 300. Next, the process applies the first subframe of data to the display with the light source for the display having a relatively high intensity, Step 400. Next, the process applies the second frame of data to the display with the light source for the display having a relatively low intensity; Step 500. The process continues until all three colors have been processed, Step 600.

Thus, the grayscale resolution is increased by providing a resolution greater than 8 bits. The on-time for each shade is subdivided in two sub-frames. During a first subframe, a full intensity light source is turned on and the imaging array processes five most significant bits of data, while least significant bits are stuffed with zeros. During a second sub frame, the light source is turned on at reduced intensity and the imaging array processes the three least significant bits, which are left-shifted.

A number of embodiments of the invention have been described. Nevertheless, it will be understood that various modifications may be made without departing from the spirit and scope of the invention. For example, the data byte for the second subframe is filled out using Digital Signal Processor (DSP) data obtained by over-sampling or interpolation. The lower order bits may be also stuffed with zeros. Further, while transmissive LCD has been described above, the invention may be applied to other types of video systems, such as, for example, three DLP or reflective LCD devices, each with its own projection lens, in a configuration similar to the earliest commercial color video projection systems.

Accordingly, other embodiments are within the scope of the following claims.

What is claimed is:

1. A method for enhancing the grayscale resolution of a display system, comprising:
receiving data having N bits for display on the display system;
presenting the frame of data to the display as a sequence of subframes of data, each subframe having a fractional portion of the N bits, each subframe of data being presented to the display with the display being illuminated with a light source having a corresponding different intensity.

2. The method recited in claim 1 wherein each one of the subframes has N bits and wherein a first one of the subframes has as the most significant bits thereof the most significant bit fractional portion of the N bits of the frame and wherein a second one of the subframes has as the most significant bits thereof the least significant bit fractional portion of the N bits of the frame.

3. The method recited in claim 2 wherein when the first one of the subframes of data is presented to the display, the display is illuminated with the light source having a relatively high intensity and wherein when the second one of the subframes of data is presented to the display, the display is illuminated with the light source having a relatively low intensity.

4. A method for enhancing the grayscale resolution of a display system, comprising: receiving a frame of data having data for each of a plurality of different colors; selecting N-bits of data from one of the plurality of different colors; separates the N-bits of data into two subframes: the first subframe having as the most significant bits thereof the N-n most significant bits of selected color data; the second subframe having as the most significant bits thereof the remaining (n) bits of selected color data; applying the first subframe of data to the display with a light source for the display having a relatively high intensity; applying the second frame of data to the display with the light source for the display having a relatively low intensity; and repeating the process until all colors have been applied to the display.

5. A system for enhancing the grayscale resolution of a display system, such system comprising:
a display;
a light source for illuminating the display; a buffer system for receiving data having N bits for display on the display and for presenting the frame of data to the display as a sequence of subframes of data, each subframe having a fractional portion of the N bits; and a controller for controlling illumination intensity of the light source with each subframe of data being presented to the display with the display being illuminated with the light source having a corresponding different intensity.

6. The system recited in claim 5 wherein each one of the subframes has N bits and wherein a first one of the subframes has as the most significant bits thereof the most significant bit fractional portion of the N bits of the frame and wherein a second one of the subframes has as the most significant bits thereof the least significant bit fractional portion of the N bits of the frame.

7. The system recited in claim 6 wherein when the first one of the subframes of data is presented to the display, the display is illuminated with the light source having a relatively high intensity and wherein when the second one of the subframes of data is presented to the display, the display is illuminated with the light source having a relatively low intensity.
